(19) United States
(12) Patent Application Publication
(10) Pub. No.: US 2005/0036664 A1
(43) Pub. Date: Feb. 17, 2005

(54) Polygonal ridge flow classification

(75) Inventor: Phillip Shawn Davis, Jupiter, FL (US)

Correspondence Address: STERNE, KESSLER, GOLDSTEIN & FOX PLLC, 1100 NEW YORK AVENUE, N.W., WASHINGTON, DC, 20005, US

(73) Assignee: Cross Match Technologies, Inc.

(21) Appl. No.: 10/884,375

(22) Filed: Jul. 6, 2004

Related U.S. Application Data
(60) Provisional application No. 60/484,324, filed on Jul. 3, 2003.

(51) Int. Cl. G06K 9/00

(52) U.S. Cl. 382/124

(57) ABSTRACT

A process in which a ridge flow analysis of a fingerprint image can be used to determine a fingerprint classification. Areas of like valued ridge flow are collected as regions and said regions are then joined together when edges of the regions exist. These vertices are then reduced to form polygons. Polygons that have a predetermined number of vertices (i.e., 8) and contain values from across a range of the possible ridge flow values (i.e., one of each possible ridge flow value) from the ridge flow table are primary polygons associated with singularity points. These singularity points are further identified as cores or deltas allowing the print image to be globally classified as loop, arch or whorl. Further techniques including, but not limited to, ridge counting can be used to classify the fingerprint as a left or right loop, plain or tented arch, or whorl.

### CROSS-REFERENCE TO RELATED APPLICATIONS

This application claims the benefit of U.S. Provisional Application No. 60/484,324, filed Jul. 3, 2003, and incorporated in its entirety herein by reference.

### STATEMENT REGARDING FEDERALLY-SPONSORED RESEARCH AND DEVELOPMENT

Not applicable.

### BACKGROUND

1Field of the Invention

The present invention relates to print image analysis.

2. Related Art

Fingerprints are often classified based on print characteristics, such as, the presence of a loop, arch, or whorl. Many classification methods are based on Henry classes which classify fingerprint images into arch, tented arch, left loop, right loop and whorl classes. FIG. 1A shows examples of print images corresponding to the respective arch, tented arch, left loop, right loop, whorl, and accidental classes. These classes are also called the global or high-level classes. These classifications are determined based on the position and type of singularity points called cores and deltas. FIG. 1B is a table listing singularity point information (cores and deltas) associated with each fingerprint pattern class. For instance, an arch can be classified as having no core or delta. A tented arch can be classified as having no core and one delta. Left and right loops also have one core and one delta. A left loop has a delta positioned to the right of the core, while a right loop has a delta positioned to the left of the core as shown in FIG. 1A. A whorl has two cores and two deltas. Finally, a accidental print can have three cores. See, e.g., Zhang et al., “Fingerprint Classifications Based on Extraction and Analysis of Singularities and Pseudoridges,” Australian Computer Society 2002, pp. 1-5.

The use of global classes can facilitate and reduce the work involved in fingerprint identification. A match can be determined by first evaluating high-level features of a print image (i.e., singularity points) to determine an appropriate global class and then evaluating low-level features that characterize an individual fingerprint, such as, ridge characteristics and minutiae.

Print scanners (also called live scanners) are devices that capture an image of a print. The captured images are often sent for further processing in an Automated Fingerprint Identification System (AFIS) or other applications. The quality of an image capture can vary depending upon a number of factors, such as, proper placement of a print on a platen, ambient conditions, and the operation of components in the live scanner itself. Accordingly, it is desirable to evaluate the quality of a captured print before storing or sending a captured print image for further processing. In this way, unsuitable print images are identified early. Steps can then be taken to re-position a finger or hand, adjust the pressure placed on the finger or hand, adjust print scanner illumination, or otherwise improve the quality of the captured print image. This avoids sending poor images to an AFIS that may be rejected for being of unacceptable quality. In many cases, what is needed is a relatively quick check of a print image to determine whether the print image is of sufficient quality that it can be classified in a corresponding global fingerprint pattern class.

What is needed is a method and system for automatically determining whether a captured print image contains data which enables the print to be classifiable. Further, what is needed is a method and system for automatically determining a fingerprint classification from a captured print image.

### BRIEF SUMMARY OF THE INVENTION

The present invention provides methods and systems for determining whether a capture print image contains data which enables the print to be classifiable according to embodiments of the present invention. Further, the present invention provides methods and systems for determining a fingerprint classification from a captured print image according to embodiments of the present invention.

In an embodiment, a method for determining a fingerprint classification includes: determining ridge flow values from print image data, determining ridge flow regions based on the determined ridge flow values, building polygons (zero, one or more) based on the ridge flow regions, and determining a singularity point in a respective built polygon. In this way, the print image data can be associated with a class in a fingerprint classification based on each determined singularity point.

According to a feature, ridge flow values can be a range of values representing different ridge flow directions of ridges in the print image data. The finding regions step can include determining ridge flow regions having like-valued ridge flow values. One further advantage is that region borders can be found using a flood-fill algorithm to determine a first set of ridge flow regions having like-valued ridge flow values.

According to a further feature, polygons are built by finding connections between ridge flow regions. This finding connections step can include determining whether ridge flow regions share a common border and have respective ridge flow values that differ by a predetermined minimum amount. Additional steps can include after said finding connection step, removing solitary regions and combining split regions to form a regrouped set of ridge flow regions, and updating the connections based on the regrouped set of ridge flow regions.

According to a further feature, singularity points can be determined by finding a set of polygons that have a predetermined length and cover a range of ridge flow values, and locating each singularity point in a respective polygon in the set. The print image can then be classified based on each located singularity point.

According to a further feature, a graphical representation can be displayed. In one example, this graphical representation can include the print image, determined ridge flow regions, and/or built polygons associated with the determined ridge flow regions. Located singularity points and an indication of the classification obtained can also be graphically displayed.

In another embodiment, a system for determining a fingerprint classification of a print image is provided. The system includes a scanner that captures a print image, and a processor. The processor determines ridge flow values based on the captured print image, determines ridge flow regions based on the determined ridge flow values, builds zero, one or more polygons based on the ridge flow regions, and determines singularity point(s) in corresponding built polygon(s).

An advantage of embodiments are conventional flood-fill algorithms can be used in the present invention to classify a print image quickly. Further, these flood-fill algorithms are used to generate display outputs of fingerprint images that provide fast, meaningful visual feedback to a user. Among other things, these display outputs allow a user to easily identify ridge flow patterns and regions with singularity point(s) in a captured print image.

Further embodiments, features, and advantages of the present inventions, as well as the structure and operation of the various embodiments of the present invention, are described in detail below with reference to the accompanying drawings.

### BRIEF DESCRIPTION OF THE DRAWINGS

FIG. 1A show conventional examples of print images corresponding to the respective arch, tented arch, left loop, right loop, whorl, and accidental classes.

FIG. 1B is a table listing singularity point data (core and delta) associated with each fingerprint pattern class.

FIG. 2 is a flowchart diagram of a polygonal ridge flow classification routine according to an embodiment of the present invention.

FIG. 3 is a flowchart diagram showing a process of building polygon(s) based on ridge flow regions used in the routine of FIG. 2 according to an embodiment of the present invention.

FIG. 4 is a flowchart diagram showing a process of determining singularity point(s) in polygons used in the routine of FIG. 2 according to an embodiment of the present invention.

FIG. 5 is a flowchart diagram showing a process of determining fingerprint classification based on singularity point(s) used in the routine of FIG. 2 according to an embodiment of the present invention.

FIG. 6 is a diagram of an example ridge flow graph and associated values for different ridge flow directions.

FIGS. 7A-7F are diagrams that show processing of an example print image according to an embodiment of the present invention. FIG. 7A is a diagram that shows an example print image and associated ridge flow direction values. FIG. 7B is a diagram of a ridge flow graph. FIG. 7C is a diagram that shows various ridge flow regions. FIG. 7D is a diagram that further shows borders of the various ridge flow regions. FIG. 7E is a diagram that shows connections between various ridge flow regions making up two polygons. FIG. 7F is a diagram that shows two singularity points (one core, one delta) located respectively with two polygons of FIG. 7E.

FIGS. 8A-8C are diagrams that show processing of another example print image according to an embodiment of the present invention. FIG. 8A is a diagram that shows an example print image and associated ridge flow direction values. FIG. 8B is a diagram that shows various ridge flow regions. FIG. 8C is a diagram that shows connections between various ridge flow regions making up polygons surrounding four singularity points (two cores, two deltas).

FIG. 9 is a diagram of a computer system according to an embodiment of the present invention.

FIG. 10 is a diagram of a polygon surrounding a tented arch (no core, one delta) in a further example print image according to an embodiment of the present invention.

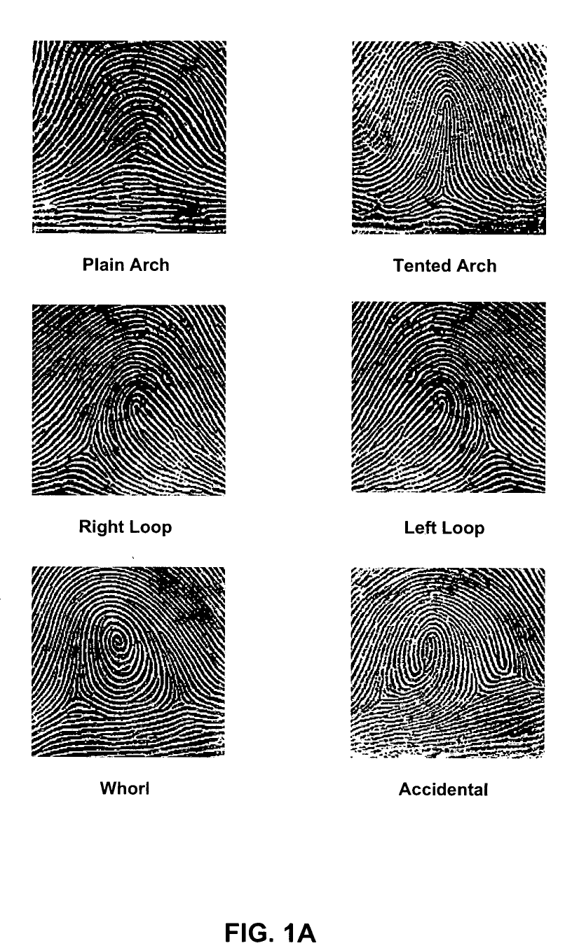

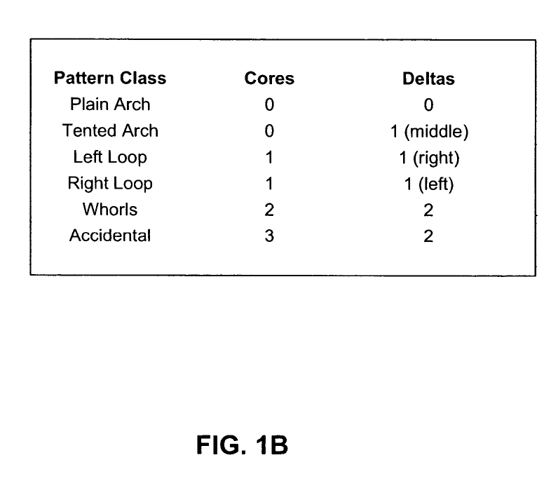

### DETAILED DESCRIPTION OF EMBODIMENT(S)

Polygonal Ridge Flow Classification

Overview

An embodiment of the present invention provides a process in which a ridge flow analysis of a fingerprint image can be used to determine a fingerprint classification. Areas of like valued ridge flow are collected as regions and said regions are then joined together when edges of the regions exist. These vertices are then reduced to for polygons including, but not limited to, minimal circular-like or regular polygons. Each polygon is characterized by the number of vertices that create them. Polygons that have a predetermined number of vertices (i.e., eight vertices for the case of 8 ridge flow directions) and contain one value from each of the possible ridge flow values from the ridge flow table are deemed to be a singularity. In one example, these singularities are then further identified based on a clockwise or counter-clockwise direction. Clockwise singularities are identified as cores and counter-clockwise singularities are identified as deltas. Further techniques using ridge counting can be used to correctly classify the fingerprint.

This algorithm for determining a fingerprint classification based on ridge flow analysis of a fingerprint image can be implemented in software, firmware, hardware or any combination thereof. The algorithm can be implemented in a computer or other processing device, in a live scanner itself, or distributed therebetween.

Terminology

Ridge Flow Table—A table of values in a range (including but not limited to an example range from 0 to 7) representing a direction or angle of the ridges in a print image.

Region Table—A table representing a ridge flow region including, but not limited to, an identical size of the ridge flow table representing a region number identified in this area of the fingerprint.

Ridge Flow Region—Like-valued ridge flow information connected by position (such as within one square from each other).

Connection—When a region touches another region in multiple positions (such as 3 or more positions) a connection can be formed therebetween.

Polygon—A multi-vertices polygon (such as 4 to 12 vertices) defined by connections of the regions.

Singularity point—A point of interest to a fingerprint classification, such as a core or a delta.

Core—A central area of a fingerprint. Ridges will flow around cores. Some prints will have zero, one, two, or three cores.

Delta—A split in the flow of the fingerprints. Some prints will have zero, one or two deltas.

Vertex—A point at a position within a region used as an end point of a connection (such as an average position or center of a region).

Polygon—A polygon with multi-vertices (i.e., 8 vertexes) all associated with different ridge flow values. A polygon can include, but is not limited to, polygons having a generally or approximately circular, circular-like or regular polygonal shape.

Ridge Count—An algorithm technique used to count the number of ridges between any two points of a print image.

Algorithm

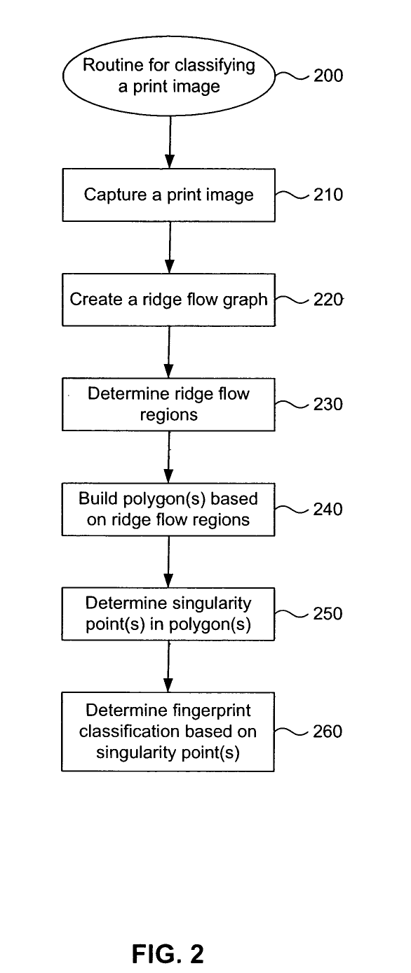

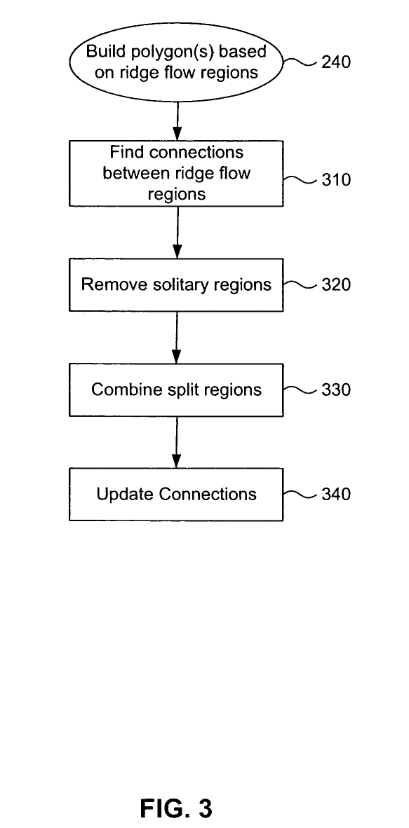

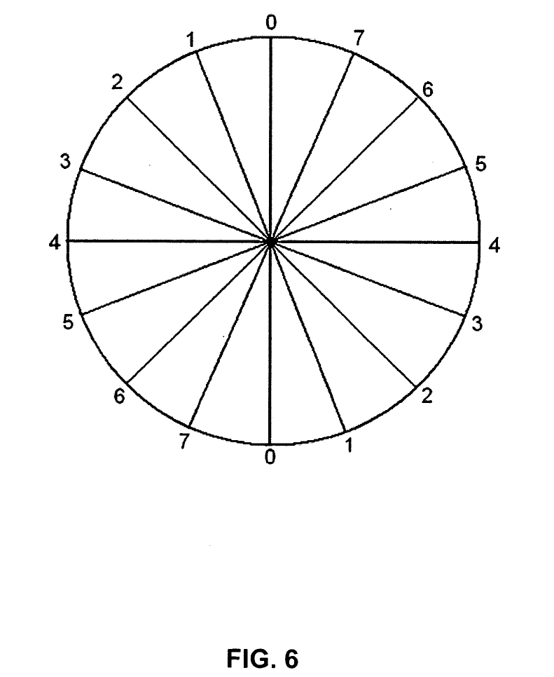

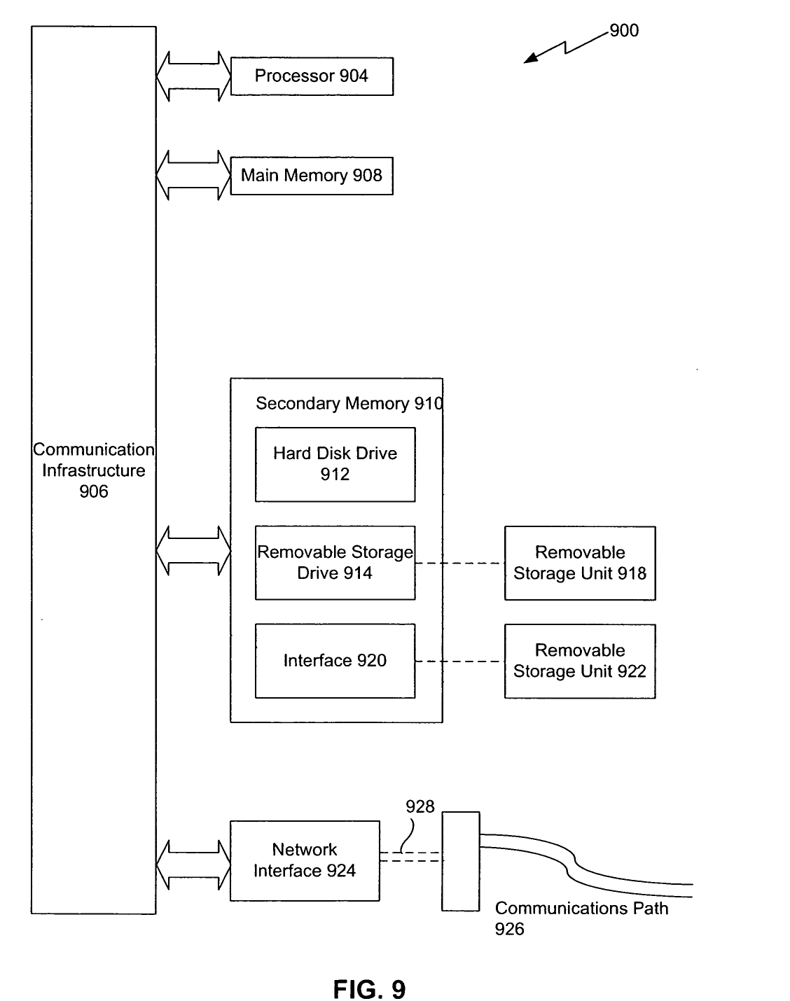

FIG. 2 is a flowchart diagram of a polygonal ridge flow classification routine 200 according to an embodiment of the present invention (steps 210-260). Routine 200 will be described with respect to steps 210-260 as shown in FIG. 2 and additional processes shown in FIGS. 3-5. Reference will also be made to examples shown in FIGS. 6-8 and 10. An example computer system in which routine 200 can be implemented is described with respect to FIG. 9.

In step 210, a print image is captured. For example, a person can place a finger in a sensing area on a live scanner. A camera or other type of sensor device (e.g., an optical, capacitive, ultrasonic, or piezoelectric sensor) can then detect an image of a print on the finger. Data representing the print image is then stored in memory.

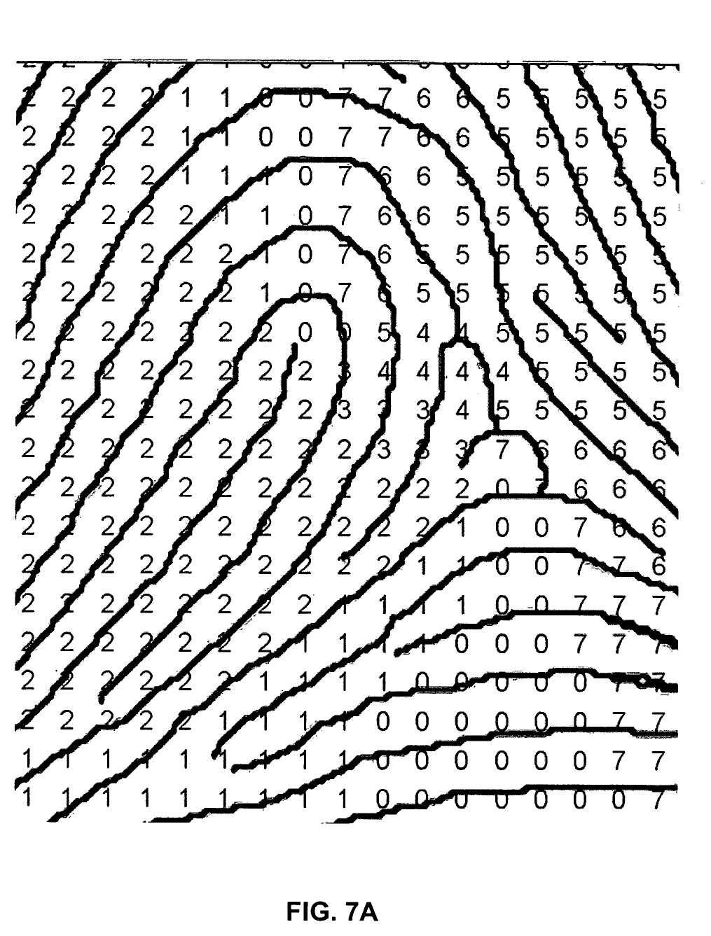

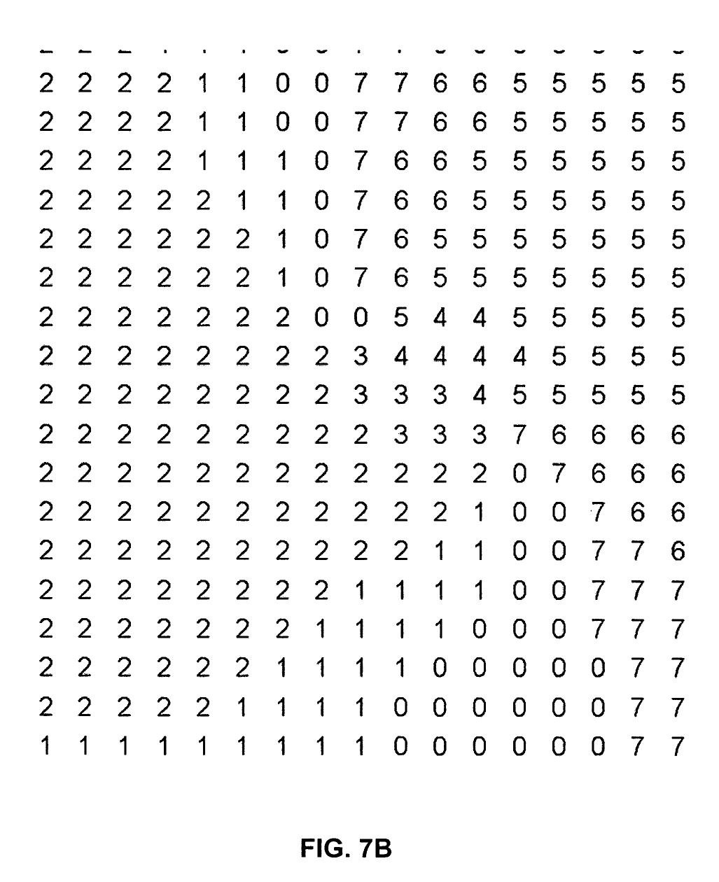

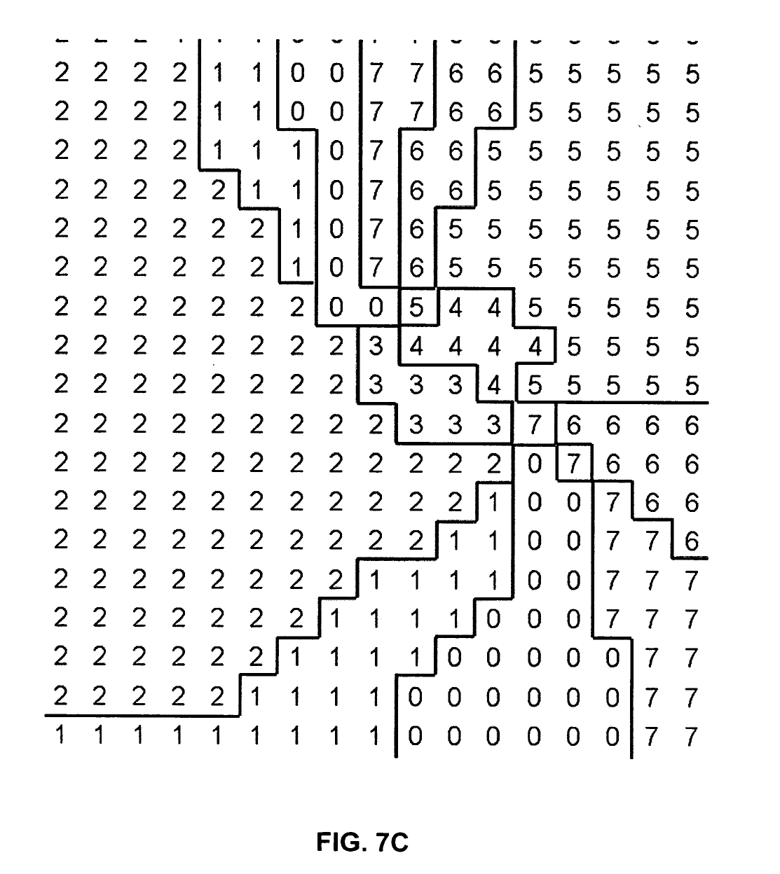

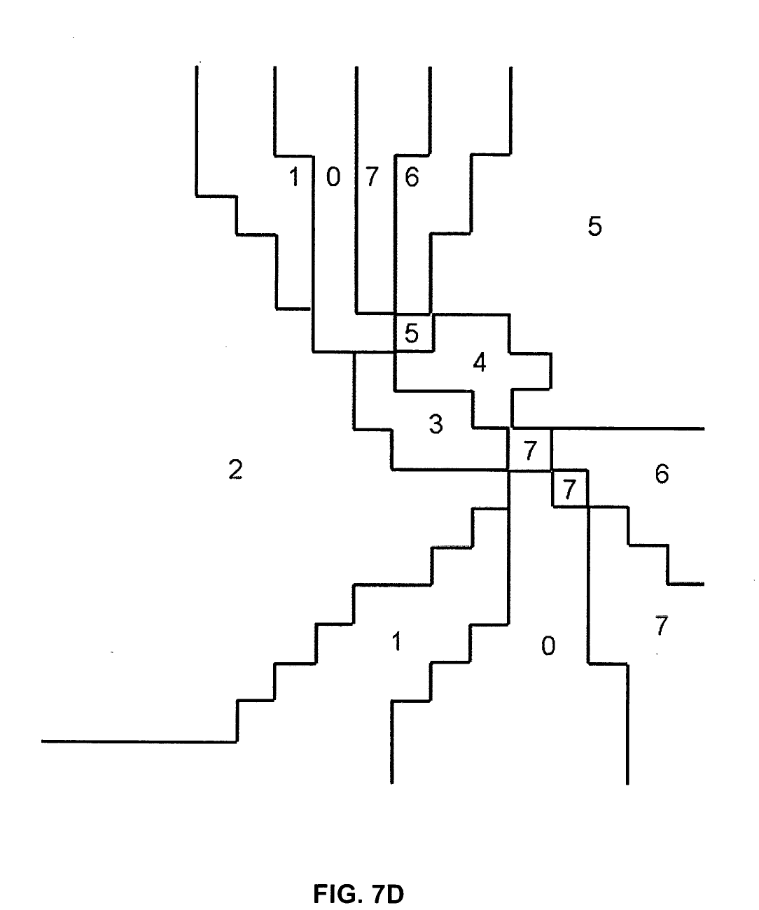

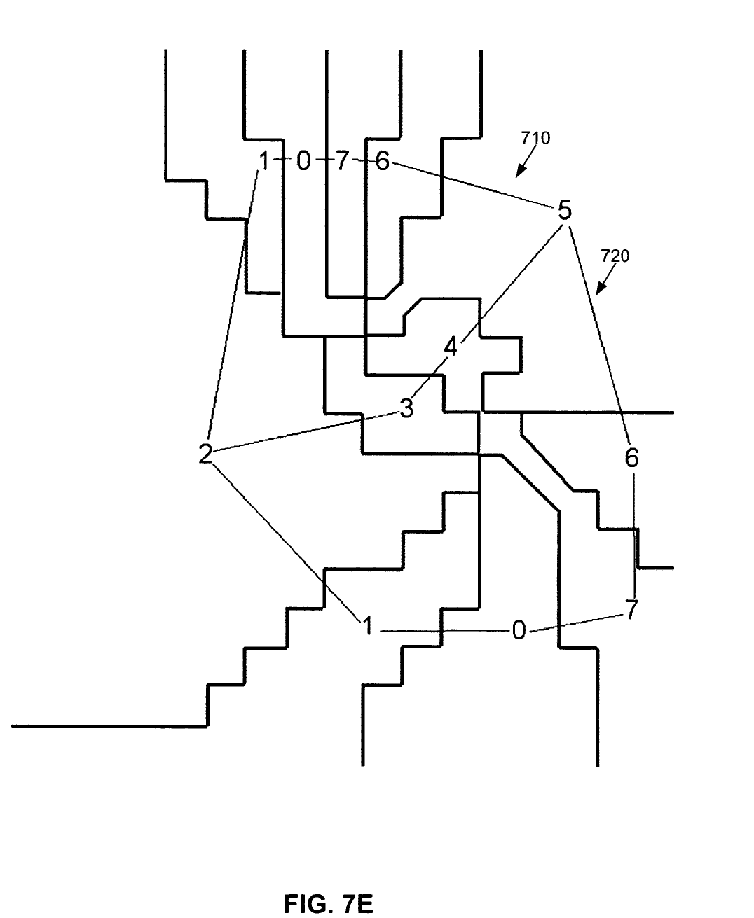

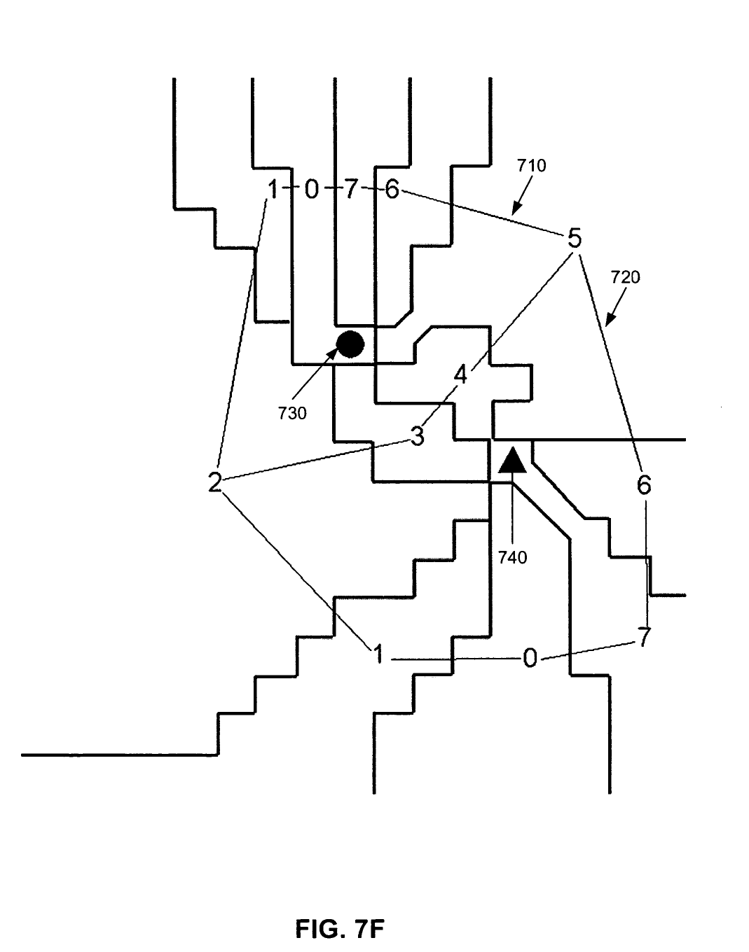

In step 220, a ridge flow graph of the captured print image is created. The ridge flow graph is a data structure containing data representing the angle of ridge flow at various ridge locations across the print image. Any type of data structure can be used including, but not limited to, a table. Many algorithms exist for creating a simple ridge flow graph. For example, public domain National Institute of Standards and Technology (NIST) algorithms can be used to generate this array. FIG. 6 shows an example ridge flow graph and associated values for different ridge flow directions. The values from the array range from 0 (straight up), 3 (flat) to 7 (nearly straight down). A value of −1 means that the value represents an unusable background area and should be ignored. This creates a ridge flow table that one can use for the rest of the algorithm. Each value in the table will represent an area (such as, an 8 pixel×8 pixel area) of the original fingerprint. FIG. 7A is a diagram that shows an example print image and associated ridge flow direction values (0-7) according to an embodiment of the present invention. FIG. 7B is a diagram of a ridge flow graph containing the ridge flow direction values of the example of FIG. 7A.

In step 230, ridge flow regions are determined. A ridge flow region table (or simply region table) is created that mimics the ridge flow table in size. This ridge flow region table stores a region index that each ridge flow value represents. In this way, regions of the print image having common ridge flow values are grouped.

According to a further feature, to determine ridge flow regions a standard flood-fill algorithm (commonly used in paint programs) is used to browse the ridge flow graph table looking for positive ridge flow values. Once a new, different value has been found, a new region is created. Flood filling is used to find all adjacent areas in this entire region of like valued entries. In one example, as the flood-fill algorithm encounters each of these areas, it negates a value of a slope to mark an area as found as well as recording the location and frequency of these adjacent areas. The entire ridge flow graph table is processed until all possible regions with common (i.e., like valued) ridge flow values have been identified and are represented in the ridge flow region table. For example, FIG. 7C is a diagram that shows various ridge flow regions (made up of like-valued ridge flow values 0-7) determined according to step 230 using the ridge flow graph of FIG. 7B. FIG. 7D is a diagram that for clarity shows the borders of the various ridge flow regions. As a further feature, each ridge flow region can be displayed with a unique color, shading overlay, or other type of identifer. This provides a visually appealing and informative display that allows a user to easily view the different ridge flow regions determined for the captured print image.

Once flood filling is complete and one or more ridge flow regions are determined, additional pruning of the regions can be performed. For example, smaller regions can be removed. If the size of the region is less than a predetermined size (such as, 3 pixel squares), the region is removed from the list of usable regions.

In step 240, polygons are built based on the ridge flow regions determined in step 230. Step 240 is described in further detail with respect to the example steps 310-340 in FIG. 3 according to an embodiment of the present invention. In step 310, connections are found between ridge flow regions. According to a further feature, using another flood-fill algorithm, the algorithm now processes each region of the region table. Where the algorithm finds a foreign region that shares a common border and the ridge flow values between these two regions differ by a predetermined amount (i.e., have a difference of one), then a connection between the two regions is recorded. These connections found in step 310 make up polygons that extend across the ridge flow regions. In the example being described with respect to FIG. 7, FIG. 7E is a diagram that shows connections between various ridge flow regions making up two polygons 710, 720.

In step 320, solitary regions (i.e., regions with few connections) are removed. For example, if a region only connects to one other region, then the solitary region is removed from the list of valid regions. The algorithm continues to remove single connected regions until every region connects to 2 or more other regions.

In step 330, split regions are combined. In some cases, a region of like-valued ridge values will have been split into two smaller regions during step 230. Step 330 compensates for this by finding a polygon with a predetermined number of vertices (i.e., only four vertices). A comparison is made of opposite angles of this polygon to see if it shares the same value. If it does, then the region is considered to be a split region. The algorithm will then remove one of the regions, remove any connections to this region, change the values in the region table to reflect the value of the newer, larger region, and update connections found between the newer, large regions (step 340). Depending upon a particular print image being processed, steps 320-340 may be optional. In general, steps 320-340 further help contribute to building polygons in step 240 that are circular-like or regular polygons of sufficient size and orientation to surround a singularity point like polygons 710, 720. Step 240 is not limited however to a particular polygon shape.

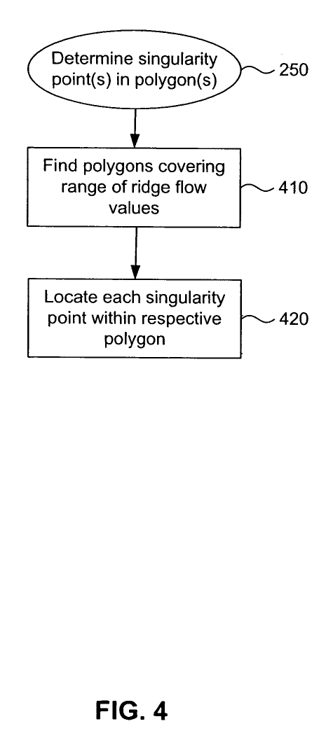

In step 250, singularity points in polygons are determined. Step 250 is described in further detail with respect to example steps 410-420 in FIG. 4 according to an embodiment of the present invention. In step 410, polygons covering a range of ridge flow values are found within the set of polygons built in step 240. For instance, all polygons are found that have a predetermined length and include one value from each of the ridge flow tables (referred to herein as “primary polygons” for convenience). For instance, in the case of 8 different ridge flow values grouped into like valued regions that have identical or an adjacent ridge flow value, the predetermined length can be 8. In the example of FIG. 7, polygons 710, 720 are primary polygons as they have a length 8 and include one ridge flow value for each of the values 0-7.

In step 420, each singularity point within a respective primary polygon is located. In one embodiment, a 7×7 pixel array is used to find the point in the region table that contains the maximum number of regions available. If at least 6 regions of a primary polygon are found, then that point is recorded. When the entire region table has been processed, the recorded points are then averaged to find the singularity point. If a primary polygon has no points that include at least 6 local regions, then the primary polygon is deemed invalid and it is removed. In certain cases, a primary polygon may encompass two or more smaller polygons including but not limited to circles. To compensate, a check is made to see if any polygon contains the vertices of a smaller polygon. If so, then that polygon is deemed to be a combination of one or more smaller polygons and is removed.

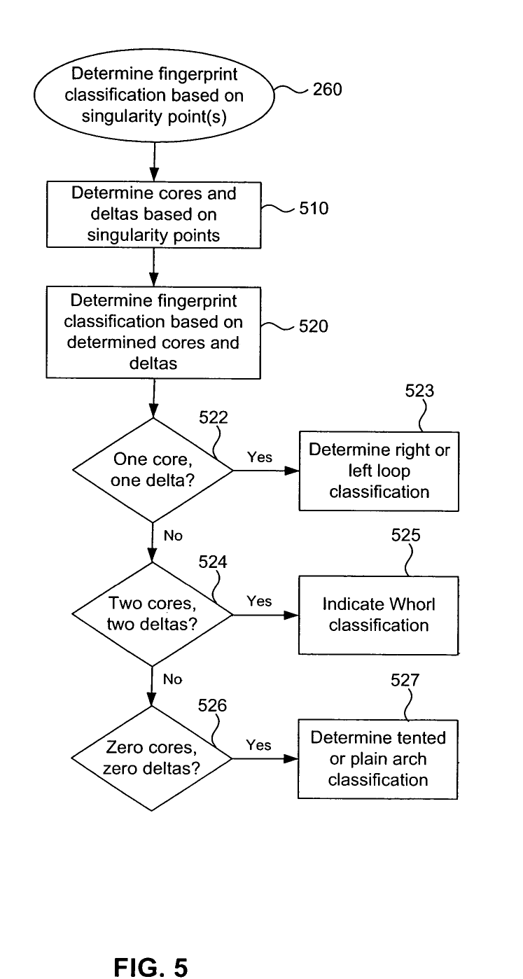

In step 260, a fingerprint classification is determined based on the singularity points in primary polygons determined in step 250. Step 260 is described in further detail with respect to example steps 510-527 in FIG. 5 according to an embodiment of the present invention.

In step 510, a number of cores and deltas are determined based on the singularity points determined in step 250. In an embodiment, the algorithm determines the polar direction between the singularity and the vertices that are contained in the primary polygon (such as a circular-like or regular polygon). Each direction is compared to the previous direction and the result is a positive or negative angle. If a majority or all of the differences is positive (which represents a clockwise direction), then the area represents a core. If a majority or all of the differences are negative (which represents a counterclockwise direction), then the area represents a delta. A count is then obtained of the number of cores and deltas. FIG. 7F is a diagram that shows two singularity points (one core 730, one delta 740 corresponding to a loop classification) located respectively with two polygons 710, 720.

A core direction can also be determined. Typically, ridges in the direction of the core are perpendicular to the core, while ridges surrounding the core are parallel. According to a further aspect of the present invention, a ridge count algorithm is used to determine where the ridges are perpendicular. From the core, a ridge count is calculated 75 pixels away from the core's position. It is then recalculated approximately every 15 degrees in a full 360 degree circle. The minimal ridge counts values are remembered, and when the process is complete, the directions of these minimum values are averaged to calculate the final direction of the core (left or right—for assisting with discriminating between a left and right loop classification).

In addition, sometimes the fingerprint image has smudges or extraneous data that can trick even the best of algorithms. If a core appears significantly below the lowest delta, then the core is assumed to be extraneous and is removed.

In step 520, the fingerprint classification of the capture print image is determined based in part on the counts and relative positions of cores and deltas in step 510. In step 522, a check for one core, one delta is made. If one core and one delta have been identified, additional loop classification techniques are used (step 523). For example, step 523 can be used in conjunction with a ridge count to distinguish whether a singularity point is a right or left loop. A ridge count algorithm can be used to assist with the classification of the loop. The number of ridges between the ridge and core are calculated and returned as the classification. For instance, a ridge count that shows the delta is located to the left of the core would indicate a right loop classification. A ridge count that shows the delta is located to the right of the core would indicate a left loop classification. Other conventional loop classification techniques can also be used to determine a left or right loop. In the case of FIG. 7F, the print image can be classified as a left loop.

In step 524, a check for two cores, two deltas is made. If two cores and two deltas have been identified, a whorl classification is indicated (Step 525). Additional whorl classification techniques can also be used to further confirm or analyze the captured print image. The whorl can be further examined to tell any variations between a central pocket whorl, plain whorl, and a double whorl using conventional whorl classification techniques.

In step 526, if zero cores and deltas have been identified, then additional arch classification techniques are used and control proceeds to step 527. In step 527, since no polygon has been found, it can be assumed that the print is an arch. Sometimes there can be no vertical ridge flow in a print, yet a complete polygon was drawn around the exterior of the print. The algorithm will begin by finding a complete polygon with length 12 or 10. If successful, one can assume that a tented arch exists. The algorithm will then attempt to find a primary polygon with length 8 or 6. If successful, it can be assumed that the print is a plain arch. Note that these primary polygons will be different than the ones used for typical classification in the fact that each vertex does not need to have one of each available value from the ridge flow table. An additional check can be made (for example after step 526) to determine whether three cores and two deltas are present, in which case an accidental class is indicated.

After step 260, control returns to process a new image or proceed with another or function.

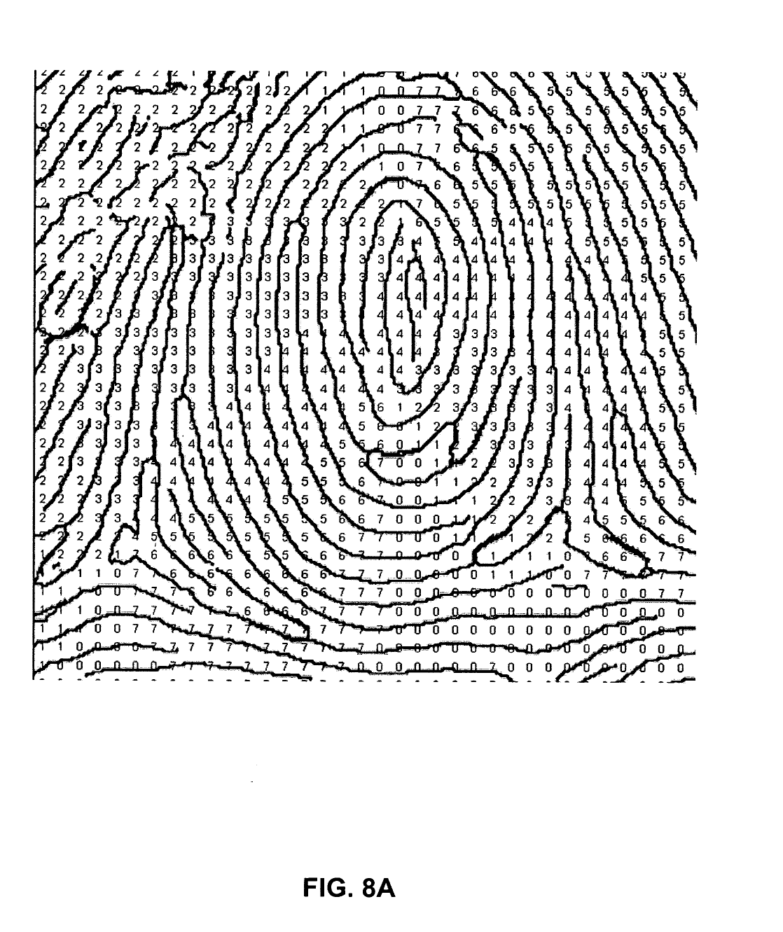

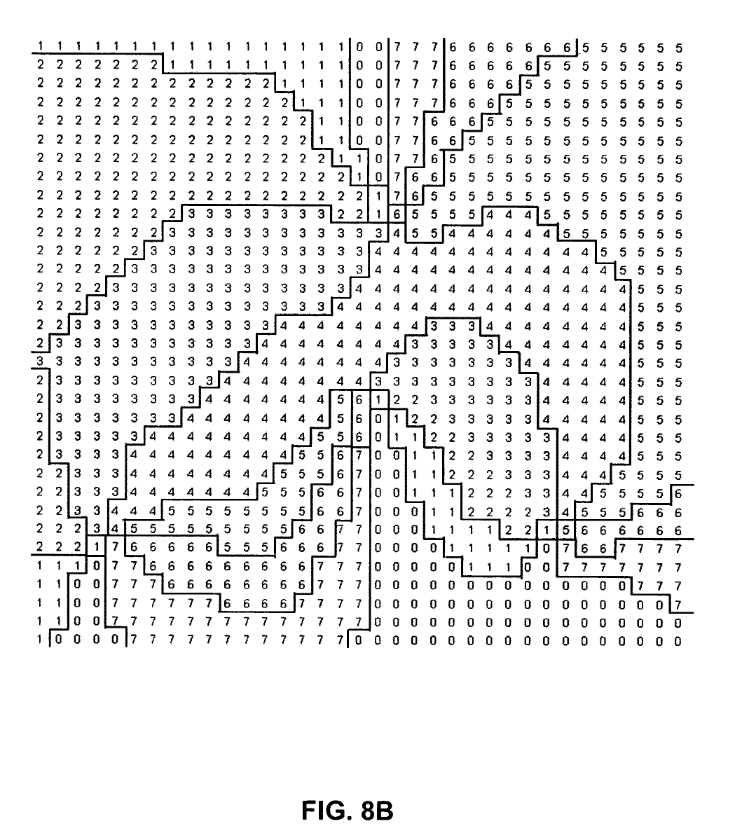

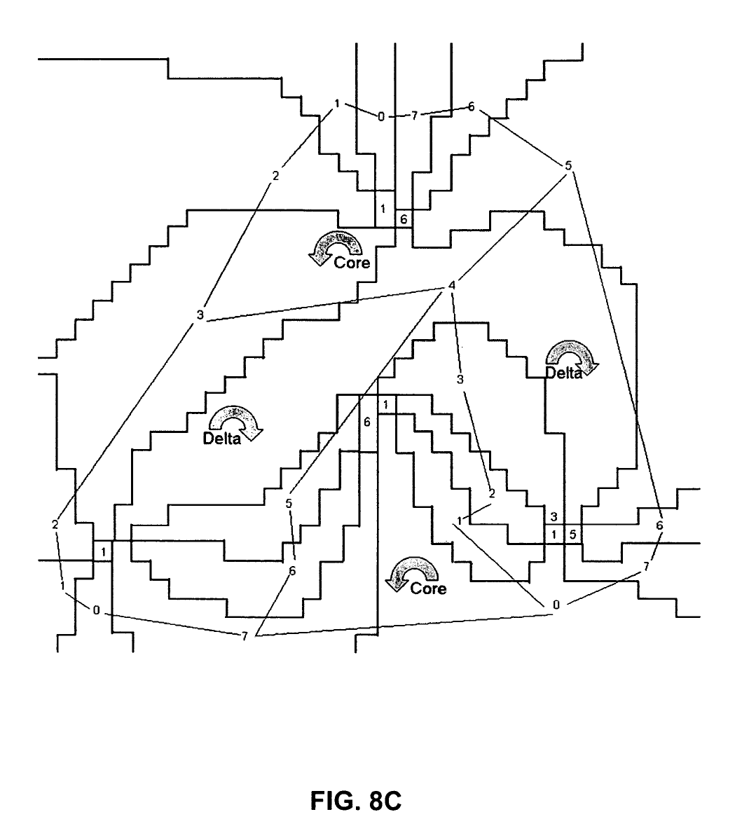

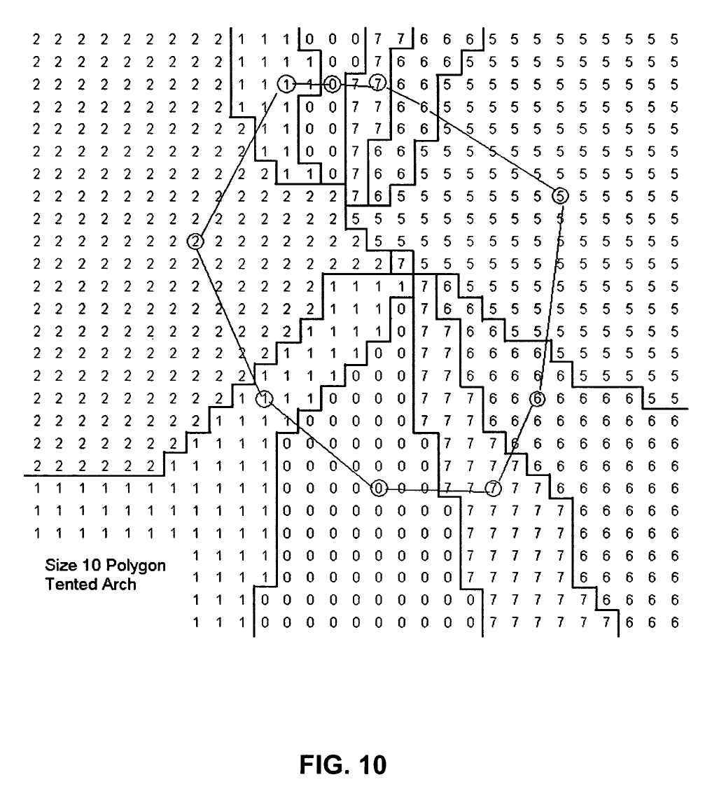

Further example print images at different stages of being classified according to an embodiment of the present invention are shown in FIGS. 8A-8C and 10. FIGS. 8A-8C are diagrams that show processing of an example whorl print image with two cores and two deltas according to an embodiment of the present invention. Routine 200 would proceed as described above with respect to the example of FIG. 7. FIG. 8A shows the example whorl print image and associated ridge flow direction values (e.g., 0-7). FIG. 8B shows various ridge flow regions having like valued ridge flow values that can be determined according to step 230. Finally, FIG. 8C shows connections between various ridge flow regions making up primary polygons surrounding four singularity points (two cores, two deltas) that can be determined for a whorl classification as described above with respect to steps 240-260.

Similarly, FIG. 10 is a diagram of a polygon having a length 10 surrounding a tented arch (no core, one delta) for another example print image. Such a polygon can be created and a tented arch classification determined as described above with respect to steps 240-260.

Example Computer System

FIG. 9 illustrates an example computer system 900, in which the present invention can be implemented as programmable code. Such programmable code can control computer system 900 to perform routine 200 and provide the control for carrying out routine 200. Various embodiments of the invention are described in terms of this example computer system 900. After reading this description, it will become apparent to a person skilled in the art how to implement the invention using other computer systems and/or computer architectures.

Computer system 900 includes one or more processors, such as processor 904. Processor 904 can be a special purpose or a general purpose processor. Processor 904 is connected to a communication infrastructure 906 (for example, a bus or network). Various software implementations are described in terms of exemplary computer system 900. After reading this description, it will become apparent to a person skilled in the art how to implement the invention using other computer systems and/or computer architectures.

Computer system 900 also includes a main memory 908, preferably random access memory (RAM), and may also include a secondary memory 910. The secondary memory 910 may include, for example, a hard disk drive 912 and/or a removable storage drive 914, representing a floppy disk drive, a magnetic tape drive, an optical disk drive, etc. The removable storage drive 914 reads from and/or writes to a removable storage unit 918 in a well known manner. Removable storage unit 918, represents a floppy disk, magnetic tape, optical disk, etc. which is read by and written to by removable storage drive 914. As will be appreciated, the removable storage unit 918 includes a computer usable storage medium having stored therein computer software and/or data.

In alternative implementations, secondary memory 910 may include other similar means for allowing computer programs or other instructions to be loaded into computer system 900. Such means may include, for example, a removable storage unit 922 and an interface 920. Examples of such means may include a program cartridge and cartridge interface (such as that found in video game devices), a removable memory chip (such as an EPROM, or PROM) and associated socket, and other removable storage units 922 and interfaces 920 which allow software and data to be transferred from the removable storage unit 922 to computer system 900.

Computer system 900 may also include a communication interface 924. Communication interface 924 allows software and data to be transferred between computer system 900 and external devices. Examples of communication interface 924 may include a modem, a network interface (such as an Ethernet card), a communication port, a Personal Computer Memory Card International Association (PCMCIA) slot and card, etc. Software and data transferred via communication interface 924 are in the form of signals 928 which may be electronic, electromagnetic, optical, or other signals capable of being received by communication interface 924. These signals 928 are provided to communication interface 924 via a communication path 926. Communication path 926 carries signals 928 and may be implemented using wire or cable, fiber optics, a phone line, a cellular phone link, a radio frequency link, or any other suitable communication channel. For instance, the communication path 926 may be implemented using a combination of channels.

The terms “computer program medium” and “computer usable medium” are used generally herein to refer to media such as removable storage drive 914, a hard disk installed in hard disk drive 912, and signals 928. These computer program products are means for providing software to computer system 900.

Computer programs (also called computer control logic) are stored in main memory 908 and/or secondary memory 910. Computer programs may also be received via communication interface 924. Such computer programs, when executed, enable the computer system 900 to implement the present invention as discussed herein. Accordingly, such computer programs represent controllers of the computer system 900. Where the invention is implemented using software, the software may be stored in a computer program product and loaded into computer system 900 using removable storage drive 914, hard disk drive 912, or communication interface 924, to provide some examples.

Conclusion

While specific embodiments of the present invention have been described above, it should be understood that they have been presented by way of example only, and not limitation. It will be understood by those skilled in the art that various changes in form and details may be made therein without departing from the spirit and scope of the invention as defined in the appended claims. Thus, the breadth and scope of the present invention should not be limited by any of the above-described exemplary embodiments, but should be defined only in accordance with the following claims and their equivalents.

1. A method for determining a fingerprint classification comprising:
(a) determining ridge flow values from print image data;
(b) determining ridge flow regions based on the determined ridge flow values;
(c) building at least one polygon based on the ridge flow regions; and
(d) determining a singularity point in a respective polygon built in step (c), whereby, the print image data can be associated with a class in a fingerprint classification based on each determined singularity point.

2. The method of claim 1, wherein said ridge flow values comprise a range of values representing different ridge flow directions of ridges in the print image data.

3. The method of claim 2, wherein said determining regions step (b) comprises determining ridge flow regions having like-valued ridge flow values.

4. The method of claim 2, wherein said determining regions step (b) comprises using a first flood-fill algorithm to determine a first set of ridge flow regions having like-valued ridge flow values.

5. The method of claim 4, further comprising pruning the first set of regions found to obtain a set of usable ridge flow regions.

6. The method of claim 1, wherein said building step (c) includes finding connections between the ridge flow regions.

7. The method of claim 6, wherein said finding connections step includes determining whether ridge flow regions share a common border and have respective ridge flow values that differ by a predetermined minimum amount.

8. The method of claim 6, further comprising, after said finding connections step, removing solitary regions and combining split regions to form a regrouped set of ridge flow regions, and updating the connections based on the regrouped set of ridge flow regions.

9. The method of claim 1, wherein said determining step (d) includes:
(i) finding a set of polygons that have a predetermined length and cover a range of ridge flow values; and
(ii) locating each singularity point in a respective polygon in the set.

10. The method of claim 9, further comprising: (e) classifying the print image data based on each located singularity point.

11. The method of claim 10, wherein said classifying step (e) includes:
(i) determining whether each located singularity point is a core or delta; and
(ii) classifying the print image data as a loop, whorl or arch based on a count of the cores and deltas.

12. The method of claim 11, further comprising displaying a graphical representation of the print image data, determined ridge flow regions, and built polygons associated with the determined ridge flow regions.

13. The method of claim 12, further comprising displaying a graphical representation that identifies located singularity points and an indication of the classification obtained in said classifying step (e)(ii).

14. A system for determining a fingerprint classification comprising:
(a) means for determining ridge flow values from print image data;
(b) means for determining ridge flow regions based on the determined ridge flow values;
(c) means for building at least one polygon based on the ridge flow regions; and
(d) means for determining a singularity point in a respective polygon built in step (c), whereby, the print image data can be associated with a class in a fingerprint classification based on each determined singularity point.

15. A system for determining a fingerprint classification of a print image comprising:
a scanner that captures a print image; and
a processor that determines ridge flow values based on the captured print image, determines ridge flow regions based on the determined ridge flow values, builds at least one polygon based on the ridge flow regions, and determines at least one singularity point in the at least one built polygon.
